(19) United States
(12) Patent Application Publication
(10) Pub. No.: US 2006/0023395 A1
(43) Pub. Date: Feb. 2, 2006

(54) Systems and methods for temperature control of semiconductor wafers

(75) Inventors: Yi-Li Hsiao, Chiayi Hsien (TW); Tse-Yi Chen, Hsinchu City (TW); Jerry Hwang, Taichung City (TW); Chin-Hsin Peng, Hsinchu City (TW); Jean Wang, Hsin Chu (TW); Chen-Hua Yu, Keelung City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Taiwan Semiconductor Manufacturing Co., Ltd.

(21) Appl. No.: 11/085,354

(22) Filed: Mar. 21, 2005

Related U.S. Application Data
(60) Provisional application No. 60/592,534, filed on Jul. 30, 2004.

(51) Int. Cl. H01T 23/00

(52) U.S. Cl. 361/234

(57) ABSTRACT

Systems and methods for temperature control of semiconductor wafers are provided. An exemplary embodiment of semiconductor wafer is held by an electrostatic chuck. An exemplary embodiment of system includes a cooling apparatus connecting the electrostatic chuck. The cooling apparatus comprises an inlet, an outlet, a porous flow layer, a porous contact layer contacting the electrostatic chuck, and a porous heat exchange layer disposed between the flow layer and the contact layer. The inlet communicates with the flow layer, and the outlet communicates with the contact layer. The fluid medium is introduced into the flow layer from the inlet and sequentially flows through the heat exchange layer and the contact layer. The fluid medium is discharged from the contact layer through the outlet, thereby exchanging heat from the semiconductor wafer.

### CROSS REFERENCE TO RELATED UNITED STATES APPLICATIONS

The application claims priority from “Isothermal Planar ESC Cooling Design System”, U.S. Provisional Application No. 60/592,534, filed Jul. 30, 2004.

### BACKGROUND

The invention relates to temperature control of semiconductor wafers. More particularly, the invention relates to systems and methods for controlling the temperature of a semiconductor wafer held by an electrostatic chuck such as during integrated circuit fabrication.

In semiconductor related production processes, electrostatic chucks are conventionally employed for holding work objects, such as a semiconductor wafers, in a reaction process chamber. A high level of accuracy is required by semiconductor processing apparatuses, such as apparatuses for forming thin films on semiconductor wafers by Physical Vapor Deposition (PVD), Chemical Vapor Deposition (CVD), sputtering and the like, and dry etching apparatuses for microprocessing wafers. Generally, an electrostatic chuck attracts and holds a semiconductor wafer by electrostatic attractive force.

Conventional electrostatic chucks, however, are intended to be used in an environment with a stable temperature thereby meeting desirable critical dimension (CD) uniformity during fabrication processes. Temperature control of the wafer is therefore important when being processed or heated in high temperature environments.

In U.S. Pat. No. 4,645,218, Mayer et al. disclosed an electrostatic chuck preventing damage to the wafers due to high heat. In FIG. 1, the electrostatic chuck according to Mayer et al. comprises a cover plate 8 applied on a support body 1 by means of an adhesive. The cover plate 8 has a round aperture 8a at the center thereof for placement of a wafer A therein. Further, the support body 1 has a round protrusion 1a at the center with an electrostatic attraction body 3 applied thereto. A metallic electrode 2 is accommodated in the electrostatic attraction body 3 and connected to an external power supply (not shown).

As shown in FIG. 1, the support body 1 has a plurality of channels 7 for passing cooling medium therethrough to cool the wafer A. With the aid of coolant passing through the channels 7, the support body 1 is cooled.

### SUMMARY

Systems and methods for temperature control of semiconductor wafers are provided. An exemplary embodiment of semiconductor wafer is held by an electrostatic chuck. An exemplary embodiment of system includes a cooling apparatus connected to the electrostatic chuck. The cooling apparatus comprises an inlet, an outlet, a porous flow layer, a porous contact layer contacting the electrostatic chuck, and a porous heat exchange layer disposed between the flow layer and the contact layer. The inlet communicates with the flow layer, and the outlet communicates with the contact layer. The fluid medium is introduced into the flow layer from the inlet and sequentially flows through the heat exchange layer and the contact layer. The fluid medium is discharged from the contact layer through the outlet, thereby exchanging heat from the semiconductor wafer.

An exemplary embodiment of method for temperature control of a semiconductor wafer held by an electrostatic chuck comprises the steps of providing a porous contact layer connecting the electrostatic chuck, providing a porous flow layer connecting the contact layer, providing a porous heat exchange layer between the flow layer and the contact layer, and inducing a fluid medium into the flow layer to drive the fluid medium sequentially through the flow layer, heat exchange layer and the contact layer.

### BRIEF DESCRIPTION OF THE DRAWINGS

FIG. 1 is a schematic diagram of a conventional electrostatic chuck;

FIG. 2 is a schematic diagram of an embodiment of a cooling system for cooling a semiconductor wafer held by an electrostatic chuck (ESC);

FIG. 3a is a top view of the flow layer of FIG. 2;

FIG. 3b is a top view of the heat exchange layer of FIG. 2;

FIG. 3c is a top view of the contact layer of FIG. 2; and

FIG. 3d is an enlarged view of portion P in FIG. 3c.

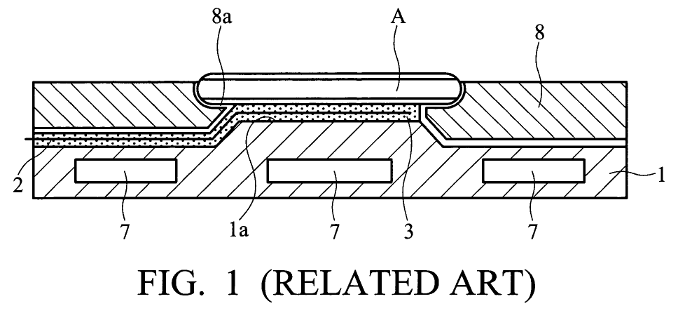

### DETAILED DESCRIPTION

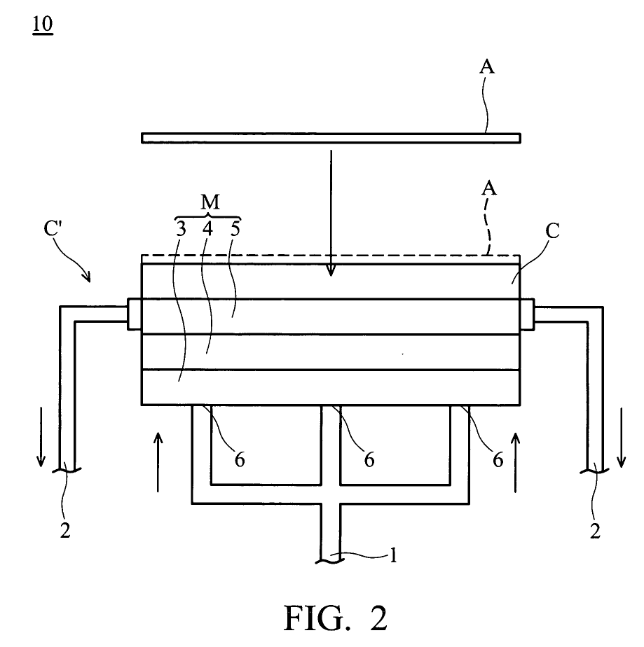

FIG. 2 is an illustrative embodiment of a cooling system for cooling a semiconductor wafer A held by an electrostatic chuck C. The cooling system 10 of FIG. 2 comprises a cooling apparatus C′ connected to the circular electrostatic chuck C. The cooling apparatus C′ comprises a main body M with an inlet 1 and several outlets 2 connected to thereto. The main body M of the cooling apparatus C′ comprises three porous redistribution layers allowing for the circulating flow of coolant driven by an external fluid medium circulating device (not shown), such as a water pump connecting the inlet 1 and outlets 2. The coolant can be water, ethylene glycol or a water/glycol mixture, for example. As shown in FIG. 2, the main body M of the cooling apparatus C′ comprises a flow layer 3, a contact layer 5, and a heat exchange layer 4 disposed therebetween. The inlet 1 communicates with the manifold holes 6 that are located in the flow layer 3. The manifold holes 6 enter the flow layer 3 at the bottom of the main body M. The outlets 2 communicate with the periphery of the contact layer 5, thereby allowing for ingress and egress of coolant as the arrows indicate in FIG. 2.

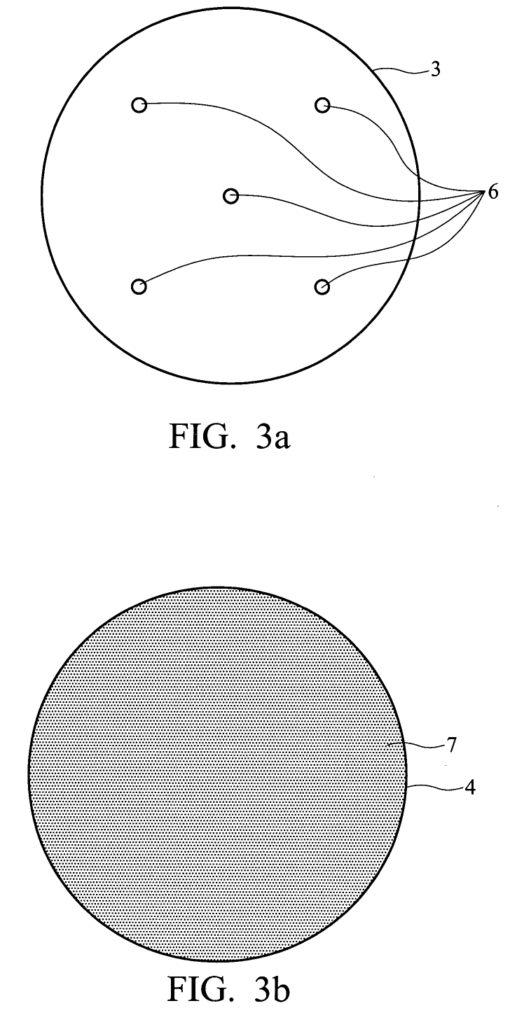

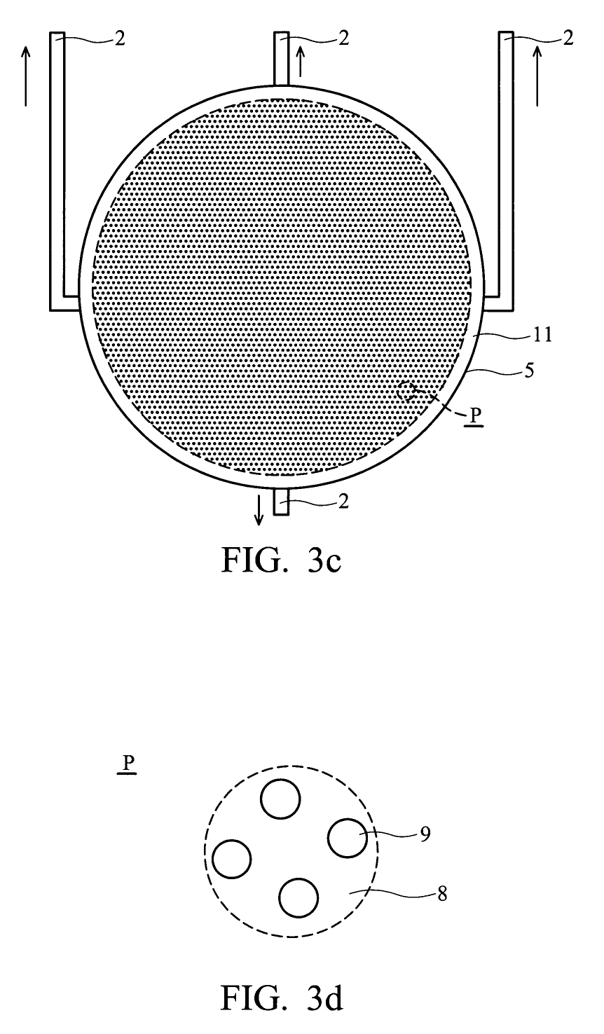

FIG. 3a is a top view of the flow layer 3. The flow layer 3 may be fine tube, porous, silk porous pillar or meshed for example, whereby coolant injected from the manifold holes 6 spreads uniformly and fills the interface between the flow layer 3 and the heat exchange layer 4. The flow layer 3 is provided to support the heat exchange layer 4 and facilitates isothermal uniformity.

Referring next to FIG. 3b, a top view of the heat exchange layer 4 is shown. As with the flow layer 3, the heat exchange layer 4 may be fine tube, porous, silk porous pillar or meshed for example. Particularly, the heat exchange layer 4 comprises a high heat conductive material such as silver, copper or metal alloy. As shown in FIG. 3b, the heat exchange layer 4 provides a plurality of small apertures 7 arranged to uniformly distribute the coolant delivered from the flow layer 3. Here, the heat exchange layer 4 can provide an isothermal planar feature in distribution of the coolant, thus facilitating temperature uniformity of the wafer A. Therefore, heat from the backside of the wafer A can be efficiently exchanged by the flow of coolant in the heat exchange layer 4.

Referring to FIG. 2 and FIG. 3c, the contact layer 5 is the upperest of the three porous redistribution layers. Contact layer 5 connects the electrostatic chuck C supporting the wafer A (heat source) for heat exchange and coolant transfer. Particularly, the contact layer 5 comprises a high heat conductive material such as silver, copper or metal alloy. As shown in FIG. 3c, the outlet 2 communicates with an annular buffer space 11 formed at the periphery of the contact layer 5 for discharging the coolant. As shown in FIGS. 3c and 3d, a pillar network is formed in the contact layer 5, comprising pillars 9 with flow space 8 formed therebetween for rapid discharge of coolant to the annular buffer space 11 in all directions. Thus, heat from the backside of the wafer A can be rapidly exchanged by the coolant in the contact layer 5. In some embodiments, the contact layer 5 can also be fine tube, porous, silk porous pillar or meshed for example. Specifically, the density of contact layer 5 is less than the heat exchange layer 4, thereby facilitating more rapid coolant delivery.

During various integrated circuit fabrication processes, especially for shallow trench isolation (STI) and polysilicon processes with plasma or non-plasma reactors, such as in Physical Vapor Deposition (PVD) and Chemical Vapor Deposition (CVD) processes, some embodiments of the electrostatic chuck (ESC) cooling system can be used to efficiently provide planar temperature control of the wafer. Potentially, this can improve the stability and isothermal uniformity of the wafer. Thus, manpower and hardware costs for temperature control during fabrication processes may potentially be reduced.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An cooling apparatus with a fluid medium flowing therein for temperature control of a semiconductor wafer held by an electrostatic chuck, comprising:
a porous flow layer, for receiving a flow of the fluid medium;
a porous contact layer connected to the electrostatic chuck;
a porous heat exchange layer, disposed between the flow layer and the contact layer;
an inlet, communicating with the flow layer; and
an outlet, communicating with the contact layer, wherein the fluid medium is induced into the flow layer from the inlet and sequentially flows through the heat exchange layer and the contact layer, and the fluid medium is discharged from the contact layer through the outlet thereby exchanging heat from the semiconductor wafer.

2. The cooling apparatus as claimed in claim 1, wherein the flow layer comprises a plurality of manifold holes communicating with the inlet for ingress of the fluid medium.

3. The cooling apparatus as claimed in claim 2, wherein the manifold holes are disposed at the bottom of the cooling apparatus.

4. The cooling apparatus as claimed in claim 1, wherein the contact layer comprises an annular buffer space in the periphery thereof communicating with the outlet.

5. The cooling apparatus as claimed in claim 1, wherein the density of contact layer is less than that of the heat exchange layer.

6. The cooling apparatus as claimed in claim 1, wherein the flow layer comprises a plurality of fine tubes.

7. The cooling apparatus as claimed in claim 1, wherein the flow layer comprises a plurality of porous pillars.

8. The cooling apparatus as claimed in claim 1, wherein the flow layer is meshed.

9. The cooling apparatus as claimed in claim 1, wherein the heat exchange layer comprises a plurality of fine tubes.

10. The cooling apparatus as claimed in claim 1, wherein the heat exchange layer comprises a plurality of porous pillars.

11. The cooling apparatus as claimed in claim 1, wherein the heat exchange layer is meshed.

12. The cooling apparatus as claimed in claim 1, wherein the heat exchange layer comprises silver.

13. The cooling apparatus as claimed in claim 1, wherein the heat exchange layer comprises copper.

14. The cooling apparatus as claimed in claim 1, wherein the contact layer comprises a plurality of fine tubes.

15. The cooling apparatus as claimed in claim 1, wherein the contact layer comprises a plurality of porous pillars.

16. The cooling apparatus as claimed in claim 1, wherein the contact layer is meshed.

17. A cooling system with a fluid medium flowing therein for temperature control of a semiconductor wafer held by an electrostatic chuck, comprising:
a cooling apparatus, comprising:
a porous flow layer, for receiving a flow of the fluid medium;
a porous contact layer, connecting the electrostatic chuck;
a porous heat exchange layer, disposed between the flow layer and the contact layer;
an inlet, communicating with the flow layer;
an outlet, communicating with the contact layer, wherein the fluid medium is induced into the flow layer from the inlet and sequentially flows through the heat exchange layer and the contact layer, and the fluid medium is discharged from the contact layer through the outlet thereby exchanging heat from the semiconductor wafer; and
a fluid medium circulating device, connecting the inlet and the outlet and circulating the fluid medium.

18. The cooling system as claimed in claim 17, wherein the fluid medium circulating device comprises a water pump for circulating the fluid medium through the cooling system.
